(19) United States
(12) Patent Application Publication
(10) Pub. No.: US 2010/0242463 A1
(43) Pub. Date: Sep. 30, 2010

(54) PARTICULATE MATTER CONCENTRATION MEASURING APPARATUS

(75) Inventors: Athanasios G. KONSTANDOPOULOS, Thessaloniki (GR); Fumishige Miyata, Ibi-Gun (JP); Takafumi Kasuga, Ibi-Gun (JP)

Correspondence Address: DITTHAVONG MORI & STEINER, P.C., 918 Prince Street, Alexandria, VA, 22314, US

(73) Assignees: IBIDEN CO., LTD., Ogaki-shi (JP); Athanasios G. KONSTANDOPOULOS, Thessaloniki (GR)

(21) Appl. No.: 12/694,290

(22) Filed: Jan. 27, 2010

(30) Foreign Application Priority Data
Mar. 31, 2009 (JP) PCT/JP2009/056747

(51) Int. Cl. F01N 3/021; G01M 15/10

(52) U.S. Cl. 60/324; 73/23.31

(57) ABSTRACT

A particulate matter concentration measuring apparatus configured to measure a concentration of a particulate matter in an exhaust gas that flows through a diesel engine exhaust line includes an exhaust gas collecting line, a particulate matter detection filter, and a differential pressure detecting unit. The exhaust gas collecting line branches from the diesel engine exhaust line and includes a flow path cross-sectional area smaller than a flow path cross-sectional area of the diesel engine exhaust line. The particulate matter detection filter is disposed in the exhaust gas collecting line. The differential pressure detecting unit is configured to detect a differential pressure between an inlet and an outlet of the particulate matter detection filter and disposed apart from a downstream end of the particulate matter detection filter in a direction of a flow of the exhaust gas.

### CROSS-REFERENCE TO RELATED APPLICATIONS

The present application is a continuation application of International application No. PCT/JP2009/056747, filed Mar. 31, 2009. The contents of this application are incorporated herein by reference in their entirety.

### BACKGROUND OF THE INVENTION

1. Field of the Invention

The present invention relates to an apparatus configured to measure the concentration of particulate matter (PM) in exhaust gas.

2. Discussion of the Background

FIG. 1 depicts a diesel engine exhaust gas purifying apparatus 20 disclosed in EP1916394 A1. The diesel engine exhaust gas purifying apparatus 20 includes a conventional particulate matter concentration measuring apparatus 20PM (PM sensor) for detecting the concentration of particulate matter (PM) in diesel engine exhaust gas, which mainly consists of carbon (C).

The particulate matter concentration measuring apparatus 20PM includes an auxiliary exhaust line 21A branching from an exhaust line 21; a particulate matter detection filter 22A disposed in the auxiliary exhaust line 21A; and a differential pressure measuring unit 22B for measuring a differential pressure produced between an inlet and an outlet of the particulate matter detection filter 22A. The auxiliary exhaust line 21A is provided with a flow rate measuring unit 24 and a temperature measuring unit T1. The particulate matter detection filter 22A is provided with a heater 22H. A flow rate in the auxiliary exhaust line 21A is controlled by a valve 23.

In the conventional particulate matter concentration measuring apparatus 20PM disclosed in EP1916394A1, a differential pressure ΔP between the inlet and outlet of the particulate matter detection filter 22A, a temperature T of an exhaust gas in the auxiliary exhaust line 21A, and a flow rate Q2 of the exhaust gas in the auxiliary exhaust line 21A are measured. Based on the differential pressure ΔP, the exhaust gas temperature T, and the exhaust gas flow rate Q2, a mass PM (g/h) of the particulate matter that is captured by the particulate matter detection filter 22A per unit time is calculated. Then, a concentration PM_{oonc} (g/m³) of the particulate matter in the exhaust gas is calculated from the mass PM (g/h) of the particulate matter.

If a large amount of the particulate matter accumulates in the particulate matter detection filter 22A, the accuracy of detection of the differential pressure decreases. Thus, the conventional measurement of particulate matter according to EP1916394A1 involves burning the accumulated particulate matter whenever a certain amount of the particulate matter has accumulated in the particulate matter detection filter 22A, using the heater 22H.

The conventional exhaust gas purifying apparatus 20 of EP1916394A1 also includes a particulate matter capturing filter (DPF: diesel particulate filter) 22 made of a porous ceramic and provided in the exhaust line 21. The auxiliary exhaust line 21A is connected upstream of the particulate matter capturing filter (DPF) 22 along a flow of the exhaust gas. Based on the concentration PM_{conc} (g/m³) of the particulate matter in the exhaust gas, an engine operating status, and/or a flow rate Q1 of gas that flows into the particulate matter capturing filter (DPF) 22 in the enter full filter (g/h) of the particulate matter that flows into the particulate matter capturing filter (DPF) 22 is calculated.

In the particulate matter capturing filter (DPF) 22, the particulate matter that is captured accumulates gradually, as in the particulate matter detection filter 22A. If a resultant deposit of the particulate matter in the particulate matter capturing filter (DPF) 22 is left un-removed, excessive pressure may be produced by the exhaust gas, resulting in deterioration in gas mileage or damaging the engine. Thus, in the exhaust gas purifying apparatus 20 using the particulate matter capturing filter (DPF) 22, the particulate matter that has accumulated is removed by periodically burning it within the particulate matter capturing filter (DPF) 22, thereby regenerating the particulate matter capturing filter (DPF) 22. Specifically, a high-temperature exhaust gas is caused to flow into the particulate matter capturing filter (DPF) 22 to burn the accumulated particulate matter.

According to EP1916394A1, whether the amount of particulate matter that is actually captured by the particulate matter capturing filter (DPF) 22 exceeds a regeneration threshold value can be accurately determined by determining the mass PM_{enter full filter} (g/h) of the particulate matter captured by the particulate matter capturing filter (DPF) 22.

The contents of the aforementioned document EP1916394A1 are hereby incorporated by reference herein in their entirety.

### SUMMARY OF THE INVENTION

According to one aspect of the present invention, a particulate matter concentration measuring apparatus configured to measure a concentration of a particulate matter in an exhaust gas that flows through a diesel engine exhaust line includes an exhaust gas collecting line, a particulate matter detection filter, and a differential pressure detecting unit. The exhaust gas collecting line branches from the diesel engine exhaust line and includes a flow path cross-sectional area smaller than a flow path cross-sectional area of the diesel engine exhaust line. The particulate matter detection filter is disposed in the exhaust gas collecting line. The differential pressure detecting unit is configured to detect a differential pressure between an inlet and an outlet of the particulate matter detection filter and disposed apart from a downstream end of the particulate matter detection filter in a direction of a flow of the exhaust gas.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 depicts a configuration of a conventional exhaust gas purifying apparatus;

FIG. 2 depicts an exhaust gas purifying apparatus including a particulate matter concentration measuring apparatus according to a First Embodiment of the present invention;

FIG. 3 illustrates an operation of a particulate matter detection filter in the particulate matter concentration measuring apparatus according to the First Embodiment of the present invention;

FIG. 4 illustrates an operation of a variation of the particulate matter detection filter in the particulate matter concentration measuring apparatus according to the First Embodiment of the present invention;

FIG. 5 depicts a structure of the particulate matter concentration measuring apparatus according to the First Embodiment of the present invention in detail;

FIG. 6 is a graph plotting the distance D from a downstream end of the particulate matter detection filter in the particulate matter concentration measuring apparatus according to the First Embodiment of the present invention against the exhaust gas temperature;

FIG. 7 is a graph plotting the distance D from the downstream end of the particulate matter detection filter in the particulate matter concentration measuring apparatus according to the First Embodiment of the present invention against the measurement error;

FIG. 8 depicts a configuration for measuring a true value of the amount of particulate matter during the measurement of FIG. 7;

FIG. 9 depicts a whole example of the particulate matter concentration measuring apparatus according to the First Embodiment of the present invention;

FIG. 10 depicts a variation of the particulate matter concentration measuring apparatus according to the First Embodiment of the present invention;

FIG. 11 depicts a configuration of an exhaust gas purifying apparatus including a particulate matter concentration measuring apparatus according to a Second Embodiment of the present invention; and

FIG. 12 depicts a configuration of a variation of the particulate matter detection filter according to the First Embodiment of the present invention.

### DESCRIPTION OF THE EMBODIMENTS

The embodiments will now be described with reference to the accompanying drawings, wherein like reference numerals designate corresponding or identical elements throughout the various drawings.

In the conventional particulate matter concentration measuring apparatus 20PM, when the particulate matter in the particulate matter detection filter 22A is burned, a high-temperature gas flows into the differential pressure measuring unit 22B, potentially disabling the measurement of differential pressure. Further, the high-temperature exhaust gas that flows from the diesel engine towards the particulate matter capturing filter (DPF) 22 may enter the auxiliary exhaust line 21A and further into the differential pressure measuring unit 22B.

In accordance with an embodiment of the present invention, a differential pressure detecting unit is provided apart from the downstream end of a particulate matter detection filter. This makes it easier to prevent the melting of the differential pressure detecting unit or a damage to it by its temperature exceeding its heat resistance when the particulate matter accumulated in the particulate matter detection filter is eliminated by burning, or a high-temperature gas exceeding about 600° C. flows through the exhaust line when regenerating the particulate matter detection filter. Thus, a normal operation of the particulate matter concentration measuring apparatus can be maintained.

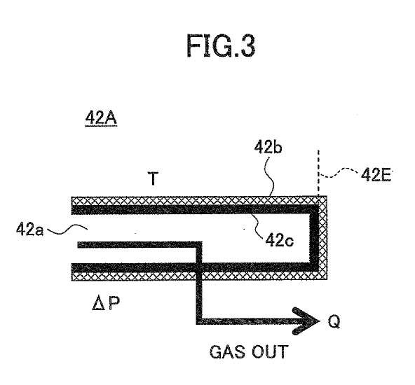

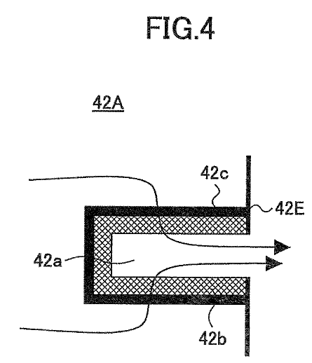

In accordance with an embodiment of the present invention, the “downstream end of the particulate matter detection filter” refers to a location the most downstream of the particulate matter detection filter where the particulate matter accumulates (see FIG. 3 or 4).

In a preferred embodiment of the present invention, the differential pressure detecting unit is provided about 10 cm or more, more preferably about 30 cm or more, apart from the downstream end of the particulate matter detection filter. In this way, the differential pressure detecting unit can be prevented from being readily exposed to the high-temperature gas, thereby enabling a normal operation of the apparatus.

### First Embodiment

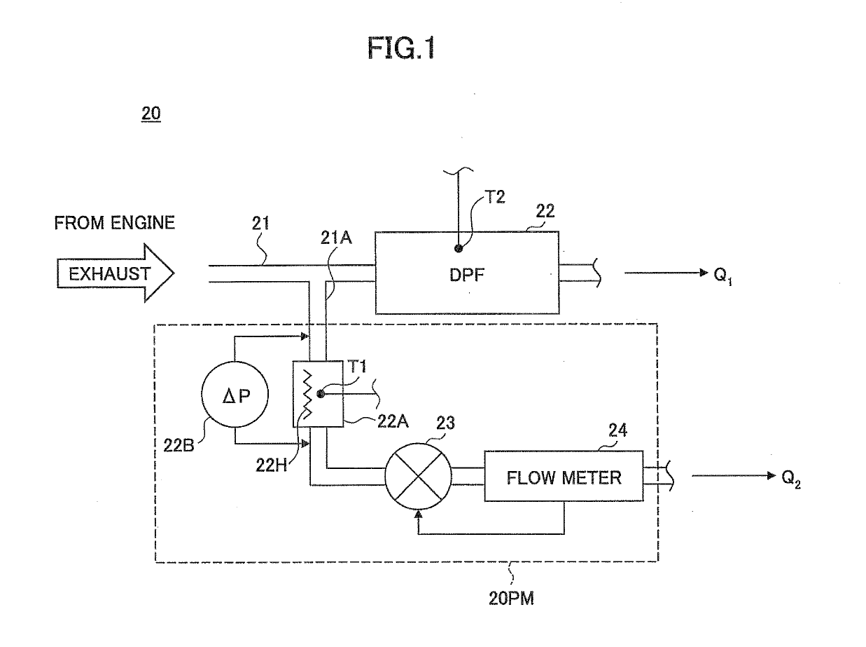

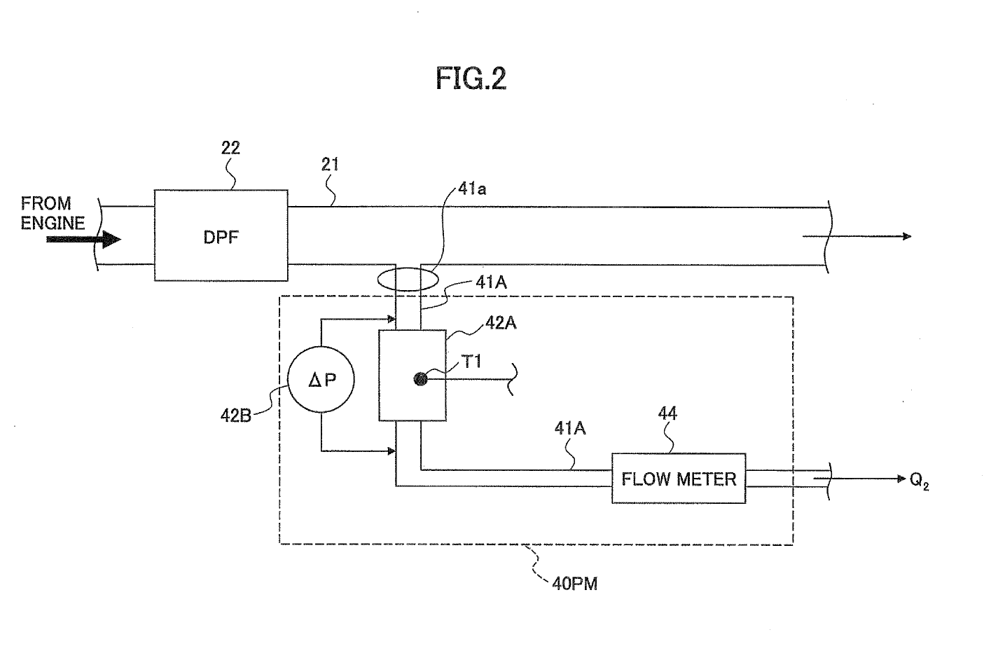

FIG. 2 depicts a diesel engine exhaust gas purifying apparatus including a particulate matter concentration measuring apparatus 40PM (PM sensor) according to the First Embodiment of the present invention. In FIG. 2, units or components similar to those of the apparatus depicted in FIG. 1 are designated with similar reference numerals or signs and their description is omitted. The particulate matter concentration measuring apparatus 40PM of FIG. 2 according to the present embodiment of the present invention may be used to detect the leakage of an amount of particulate matter exceeding a threshold value downstream of a particulate matter capturing filter (DPF) 22 through an exhaust line 21 due to an abnormality in the particulate matter capturing filter (DPF) 22. Upon detection of such leakage, an alarm may be issued via a buzzer, a lamp, or the like.

As depicted in FIG. 2, in a diesel engine exhaust line 21 in which a particulate matter capturing filter (DPF) 22 is disposed, an exhaust gas collecting line 41A is connected to the exhaust line 21 downstream of the particulate matter capturing filter (DPF) 22 via an exhaust gas collecting portion 41a. In the exhaust gas collecting line 41A, a particulate matter detection filter 42A depicted in FIG. 3 and a flow rate measuring unit 44 for measuring a flow rate Q2 in the exhaust gas collecting line 41A are connected in series.

A downstream end of the exhaust gas collecting line 41A is connected to a unit having a lower pressure than the pressure at the inlet of the particulate matter detection filter 42A, such as a negative pressure tank or an air intake unit, which are not shown. Such a lower-pressure unit functions effectively as a suction pump connected to the downstream side of the exhaust gas collecting line 41A. Accordingly, the exhaust gas in the exhaust line 21 can be sucked and reliably supplied to the particulate matter detection filter 42A in the exhaust line 21.

The particulate matter detection filter 42A includes a temperature measuring unit T1 for measuring a temperature of the particulate matter detection filter 42A. A differential pressure measuring unit 42B is also provided to measure a differential pressure ΔP across the particulate matter detection filter 42A. A cross-sectional area of the flow path of the exhaust gas collecting portion 41a is smaller than that of the exhaust line 21.

The differential pressure measuring unit 42B may use a known pressure gauge of various kinds, such as a diaphragm type, a bellows type, or a thermal type. The flow rate measuring unit 44 may use various known flow rate meters, such as a hot-wire flow rate meter or a Venturi flow rate meter.

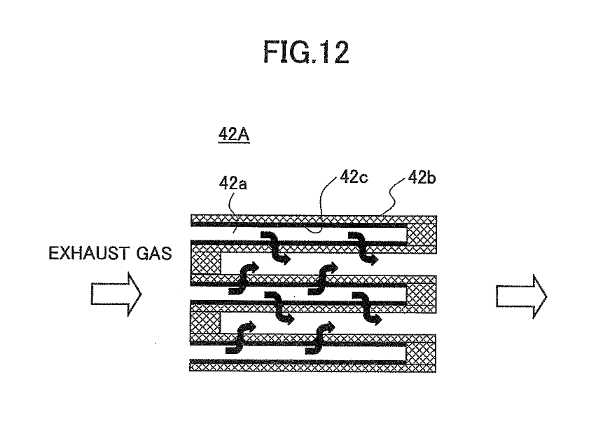

FIG. 3 depicts an example of the particulate matter detection filter 42A according to the First Embodiment of the present invention. In this example, a single cell 42b is formed within the particulate matter detection filter 42A. In another example, plural cells 42b may be formed in the particulate matter detection filter 42A, as depicted in FIG. 12. The particulate matter detection filter 42A may use a plate-shaped filter. Each cell 42b, which may be made of a porous ceramic, includes a gas passage 42a of which one end may be open and the another end may be closed.

According to the present embodiment, the particulate matter detection filter 42A includes one or more gas passages 42a which may have, as a whole, a volume of about 5% or less, such as about 0.05% to about 5% of a total volume of the exhaust gas passages in the particulate matter capturing filter (DPF) 22. For example, the one or more gas passages 42a have a total volume of about 65 ml or less, such as about 0.05 ml to about 65 ml, and a filtering area of about 0.1 cm² to about 1000 cm² (preferably between about 1 cm² and about 10 cm²). The one or more gas passages 42a may have a rectangular cross section, with its one end closed (in FIG. 3, the rear of the passage is closed).

With reference to the First Embodiment of the present invention depicted in FIG. 3, the exhaust gas introduced into the gas passage 42a passes through a cell wall of the porous ceramic and moves into an adjacent gas passage. At this time, the particulate matter is captured on an internal wall surface of the cell 42b, forming a particulate matter layer 42c.

FIG. 4 depicts a variation of the cell 42b according to the First Embodiment of the present invention depicted in FIG. 3. In the cell 42b of FIG. 4, the exhaust gas flows from the outside of the cell 42b through the cell wall into the gas passage 42a inside the cell 42b. In this case, a deposit of the particulate matter layer 42c is formed on the external walls of the cell 42b. In the filter depicted in FIG. 12, the cells depicted in FIGS. 3 and 4 are alternately adjacently formed.

Although similar cells are formed in the conventional particulate matter capturing filter (DPF) 22 described with reference to FIG. 1, the gas passage 42a and the cell 42b of the particulate matter detection filter 42A do not necessarily need to have substantially the same size or substantially the same cross sectional shape as the gas passages in the particulate matter capturing filter (DPF) 22. The gas passage 42a and the cell 42b may have any desired cross-sectional shape, such as a substantially circular, substantially square, substantially octagonal, or substantially elliptical shape.

The material of the porous ceramic of the particulate matter detection filter 42A (cell 42b) may be different from the porous ceramic of the particulate matter capturing filter (DPF) 22. The material of the particulate matter detection filter 42A (cell 42b) may not even be ceramic. The gas passages 42a may have a total volume of about 5% or less of the total volume of the exhaust gas passages in the particulate matter capturing filter (DPF) 22, or a volume of about 65 ml or less, and a filtering area of about 0.1 to about 1000 cm² (preferably about 1 to about 10 cm²). In this way, a uniform deposit of the particulate matter layer 42c can be formed on the cell 42b. As a result, the amount of particulate matter deposition in the particulate matter detection filter 42A can be simply and accurately measured, as described below.

In the particulate matter concentration measuring apparatus 40PM according to the First Embodiment of the present invention depicted in FIG. 2, the accumulated amount of the particulate matter captured in the particulate matter detection filter 42A may be calculated by the following equation:

$$Δ P = \frac{μ Q}{2 {V}_{trap}} {( α + Ws )}^{2} [ \begin{matrix}\frac{Ws}{Kw α} + \frac{1}{2 {K}_{soot}} ln ( \frac{α}{α - 2 W} ) + \\ \frac{4 {FL}^{2}}{3} ( \frac{1}{{( α - 2 W )}^{4}} + \frac{1}{{α}^{4}} )\end{matrix} ] + \frac{ρ {{Q}^{2} ( α + Ws )}^{4}}{{V}_{soot}^{2}} [ \frac{β Ws}{4} + 2 {ζ [ \frac{L}{α} ]}^{2} ] \qquad ( Equation 1 )$$

where “ΔP” is a differential pressure expressed in (Pa) unit; “μ” is a dynamic coefficient of viscosity expressed in (Pa·s) unit; “Q” is an exhaust gas flow rate expressed in (m³/s) unit; “α” is a length of one side of the cell expressed in (m) unit; “ρ” is an exhaust gas density expressed in (g/m³) unit; “Vₜᵣₐₚ” is a filter volume expressed in (m³) unit; “Ws” is a wall thickness expressed in (m) unit; “Kw” is a gas permeability of a wall expressed in (m⁻¹) unit; “Kₛₒₒₜ” is a gas permeability of a captured particulate matter layer expressed in (m⁻¹) unit; “W” is a thickness of the captured particulate matter layer expressed in (m) unit; “F” is a coefficient (=28.454); “L” is an effective filter length expressed in (m) unit; “β” is the Forchheimer coefficient of the porous wall expressed in (m⁻¹) unit; and “ξ” is a differential pressure due to a pass through the filter expressed in (Pa) unit.

The mass “mₛₒₒₜ” of the particulate matter captured in the particulate matter detection filter 42A (cell 42b) may be expressed by the following equation:

$$W = \frac{α - \sqrt{{α}^{2} - \frac{{m}_{soot}}{{N}_{cells} \times L \times {ρ}_{soot}}}}{2} \qquad ( Equation 2 )$$

where “mₛₒₒₜ” is a mass (g) of the captured particulate matter; “N_{cells}” is a numerical aperture of an inlet-side cell; and “ρₛₒₒₜ” is a density of the captured particulate matter.

By dividing “mₛₒₒₜ” by the time (s) elapsed since the previous regeneration of the particulate matter detection filter 42A, a mass “PM” (g/s) that is captured per unit time can be obtained.

Once the mass “PM” (g/s) of the particulate matter that is deposited per unit time is determined, the particulate matter concentration “PM_{conc}” (g/m³) in the exhaust gas can be determined by the following equation:

PM(g/s)=PM_{conc}(g/m³)×Q2(m³/s) (Equation 3)

where “Q2” is an exhaust gas flow rate (m³/s) through the particulate matter detection filter 42A.

As depicted in FIG. 2, in accordance with the First Embodiment of the present invention, the particulate matter concentration measuring apparatus 40PM is disposed downstream of the particulate matter capturing filter (DPF) 22. Thus, the leakage of the particulate matter exceeding a threshold downstream of the particulate matter capturing filter (DPF) 22 through the exhaust line 21 due to an abnormality in the particulate matter capturing filter (DPF) 22 can be immediately detected, and an alarm may be issued via a buzzer, a lamp, and the like.

In a diesel engine system including the exhaust gas purifying apparatus according to the First Embodiment of the present invention depicted in FIG. 2, the particulate matter that is deposited in the particulate matter capturing filter (DPF) 22 is removed by burning, using a high-temperature exhaust gas, as mentioned above. Generally, combustion of the particulate matter produces a large quantity of high-temperature gas of temperatures equal to or more than about 600° C. to about 700° C., and some of the gas may flow into the exhaust gas collecting line 41A. Also, when the particulate matter that has accumulated in the particulate matter detection filter 42A is removed by burning with a heater, a high-temperature exhaust gas passes through the exhaust gas collecting line 41A. Consequently, a thin film in the diaphragm pressure gauge or a distortion sensor used as the differential pressure measuring unit 42B may be damaged or their operation may be rendered inaccurate by the heat of the high-temperature exhaust gas, thus adversely affecting the result of measurement of particulate matter concentration.

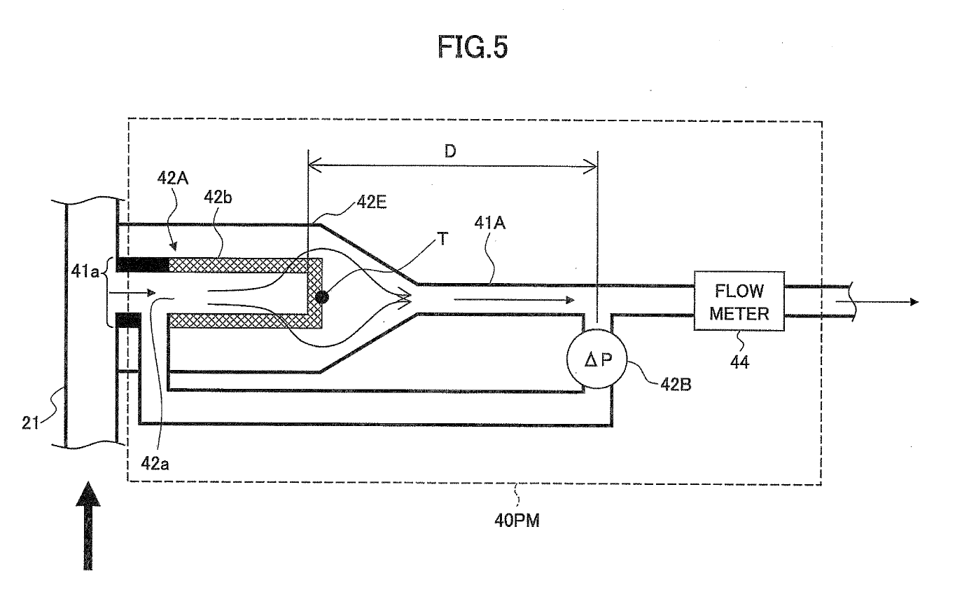

Thus, in accordance with the First Embodiment of the present invention, the differential pressure measuring unit 42B is provided downstream of the flow of exhaust gas and spaced apart from the end of the particulate matter detection filter 42A by a distance “D”, as depicted in FIG. 5, which illustrates the First Embodiment in greater detail. With reference to FIG. 5, the particulate matter detection filter 42A is housed within a housing 42E continuous with the exhaust gas collecting line 41A. One end of the particulate matter detection filter 42A forms an exhaust gas collecting portion 41a. The differential pressure measuring unit 42B, which may include a diaphragm pressure gauge, is provided at the distance “D” from an internal wall surface of the downstream-side end of the particulate matter detection filter 42A.

One end of the differential pressure measuring unit 42B is connected to an upstream portion of the particulate matter detection filter 42A. The other end of the differential pressure measuring unit 42B is connected to the exhaust gas collecting line 41A downstream of the particulate matter detection filter 42A. Thus, the differential pressure measuring unit 42B can measure the differential pressure between the inlet and outlet of the cell 42b of the particulate matter detection filter 42A.

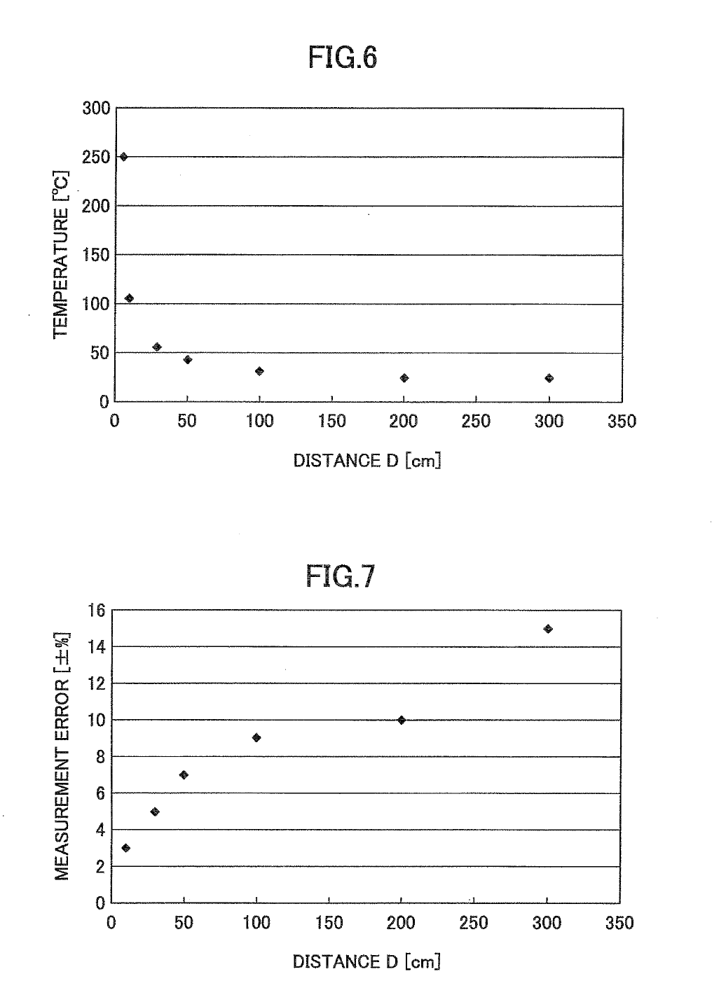

FIG. 6 is a graph plotting the distance “D” from the downstream end of the particulate matter detection filter according to the First Embodiment of the present invention against the exhaust gas temperature. In an experiment, 10 g/L of particulate matter was deposited in the particulate matter detection filter 42A of the particulate matter concentration measuring apparatus 40PM depicted in FIG. 2, and the deposit of the particulate matter was combusted by heating the particulate matter detection filter 42A to a temperature of 650° C. with the heater. The temperature of the differential pressure measuring unit 42B is plotted against the distance “D” in a graph of FIG. 6.

With reference to the graph of the First Embodiment of the present invention depicted in FIG. 6, the temperature of the differential pressure detecting unit 42B exceeds about 120° C. when the distance “D” is less than about 10 cm. It can be seen from this result that, when the heat resistance of the pressure gauge in the differential pressure measuring unit 42B is about 120° C. or less, the distance “D” should be at least about 10 cm in order to prevent damage to the pressure gauge.

As seen from FIG. 6, the greater the distance “D” of the differential pressure measuring unit 42B from the end of the particulate matter detection filter 42A, the lower the temperature of the exhaust gas tends to become. However, if the distance “D” is excessive, a measurement error in the measured differential pressure tends to increase. At the same time, in order to obtain an accurate differential pressure measurement, the distance “D” should be minimized.

Table 1 below and the graph of FIG. 7 show results of determining a measurement error in the particulate matter concentration measuring apparatus 40PM according to the present embodiment of the present invention for various values of the distance “D”. With reference to the results in Table 1, the measurement error indicates discrepancies of particulate matter concentrations calculated by Equations 1 to 3 from actual measurement values (“true values”, as will be described later) of the particulate matter in the exhaust line 21 in the configuration of the First Embodiment of the present invention in FIG. 2.

TABLE 1

| | | Temperature (° C.) at | |
|---|---|---|---|
| | Distance | differential pressure | Measurement |
| | (D) (cm) | measuring unit | error (±%) |
| Ex. 1 | 10 | 105 | 3 |
| Ex. 2 | 30 | 55 | 5 |
| Ex. 3 | 50 | 43 | 7 |
| Ex. 4 | 100 | 32 | 9 |
| Ex. 5 | 200 | 25 | 10 |
| Comp. | 5 | 250 | Melted |
| Ex. 1 | | | |
| Comp. | 300 | 25 | 15 |
| Ex. 2 | | | |

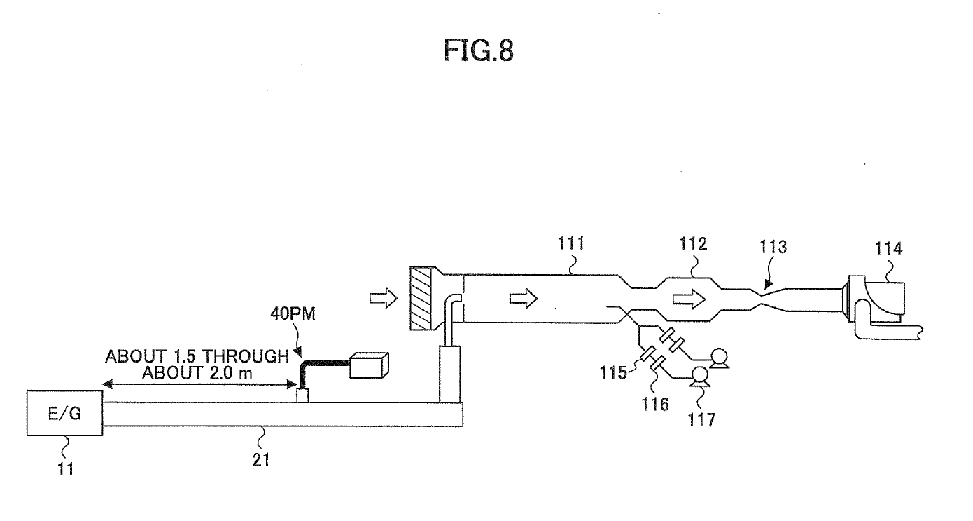

The true values may be determined using a particulate matter concentration measuring apparatus according to the First Embodiment of the present invention depicted in FIG. 8. Specifically, an exhaust gas discharged by the diesel engine 11 into the exhaust line 21 is guided to a dilution tunnel 111 into which pure air is introduced. In the dilution tunnel 111, the exhaust gas is diluted and cooled down to temperatures of 52° C. or less. The exhaust gas is then collected by a primary capturing filter 115 and a secondary capturing filter 116, and the mass of the captured exhaust gas is measured with a micro balance. The amount of particulate matter in the exhaust gas is thus directly measured, and the measured value is converted into a concentration in the exhaust line 21, thus obtaining the true value.

By comparing the true value with the value (PM_{conc}) calculated from the values measured by the particulate matter concentration measuring apparatus 40PM (distance between engine (E/G) and particulate matter concentration measuring apparatus 40PM is about 1.5 through about 2.0 m) connected to the same exhaust line 21, the measurement errors in Table 1 are determined.

In the configuration of the particulate matter concentration measuring apparatus according to the First Embodiment of the present invention depicted in FIG. 8, the exhaust gas, after passing through the dilution tunnel 111, is sucked by a blower 114 via a heat exchanger 112 and a critical flow Venturi tube 113. A second blower 117 is also provided downstream of the primary capturing filter 115 and the secondary capturing filter 116 to suck the exhaust gas.

With reference to the results shown in Table 1 and the graph of FIG. 7, in Examples 1 through where the distance “D” is 10 cm to 200 cm, the measurement error is ±10% or less. In Comparative Example 1 where the distance “D” is 5 cm, the diaphragm pressure gauge of the differential pressure measuring unit 42B is damaged by melting. It is also seen that when the distance “D” exceeds 200 cm, the measurement error of the particulate matter concentration measuring apparatus 40PM exceeds ±10%.

Thus, in the particulate matter concentration measuring apparatus 40PM according to the present embodiment, the distance “D” is preferably about 10 cm or more and about 200 cm or less and more preferably about 10 cm or more and about 50 cm or less, when the heat resistance of the differential pressure measuring unit 42B is about 120° C.

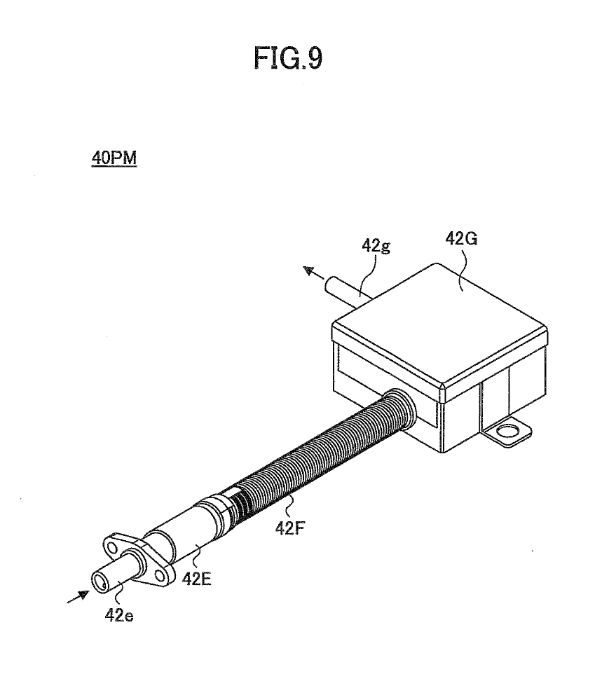

FIG. 9 depicts an example of the particulate matter concentration measuring apparatus 40PM according to the present embodiment that is configured to be inserted into the exhaust line 21 of the exhaust gas purifying apparatus according to the First Embodiment of the present invention depicted in FIG. 2 downstream of the particulate matter capturing filter (DPF) 22. In this example, the particulate matter concentration measuring apparatus 40PM includes a pipe-shaped housing 42E having a fixing head portion 42e, a flexible hose 42F, and a control unit 42G.

The flexible hose 42F connects the housing 42E and the control unit 42G, which is located downstream of the gas flow. The control unit 42G houses the differential pressure measuring unit 42B and the flow rate measuring unit 44. The exhaust gas that has passed through the control unit 42G is discharged via an exhaust pipe 42g. The housing 42E, which may be made of a heat-resistant metal, such as stainless steel, houses the particulate matter detection filter 42A, which is preferably made of a porous ceramic, such as SiC. The fixing head portion 42e forms a part of the exhaust gas collecting line 41A connected to the exhaust line 21.

In this example, the size of the particulate matter concentration measuring apparatus 40PM can be more readily reduced, allowing the particulate matter concentration measuring apparatus 40PM to be installed at a desired location of an automobile as needed, for example.

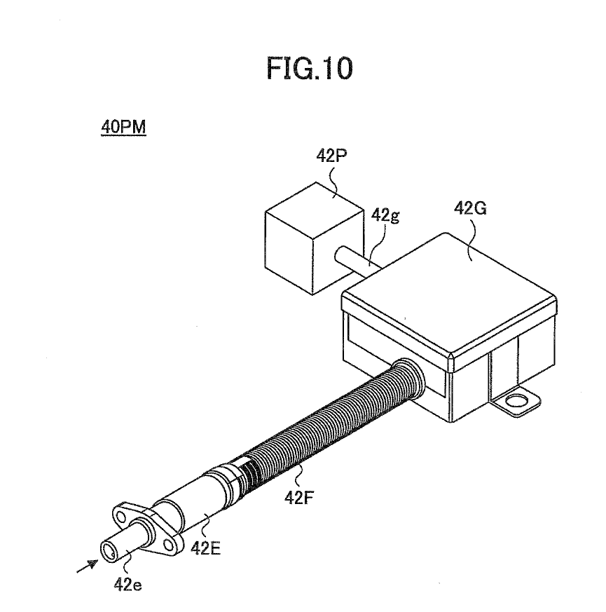

FIG. 10 depicts a variation of the particulate matter concentration measuring apparatus 40PM of FIG. 9. In this example, a pump 42P is connected to the exhaust pipe 42g in order to compulsively discharge the exhaust gas from the control unit 42G. In this configuration, when the fixing head portion 42e is provided within a stationary exhaust gas atmosphere that is not flowing, the exhaust gas can be sucked by a negative pressure produced by the pump 42P, thus enabling the measurement of particulate matter concentration.

Preferably, in the exhaust gas collecting line 41A, a heat-radiation structure is provided between the end of the particulate matter detection filter 42A downstream of the exhaust gas flow and the differential pressure detecting unit 42B. The heat-radiation structure makes the entry of the high-temperature gas into the differential pressure detecting unit more difficult, thereby eliminating the need to use heat-resistant components. In addition, the distance between the particulate matter detection filter and the differential pressure detecting unit can be reduced.

### Second Embodiment

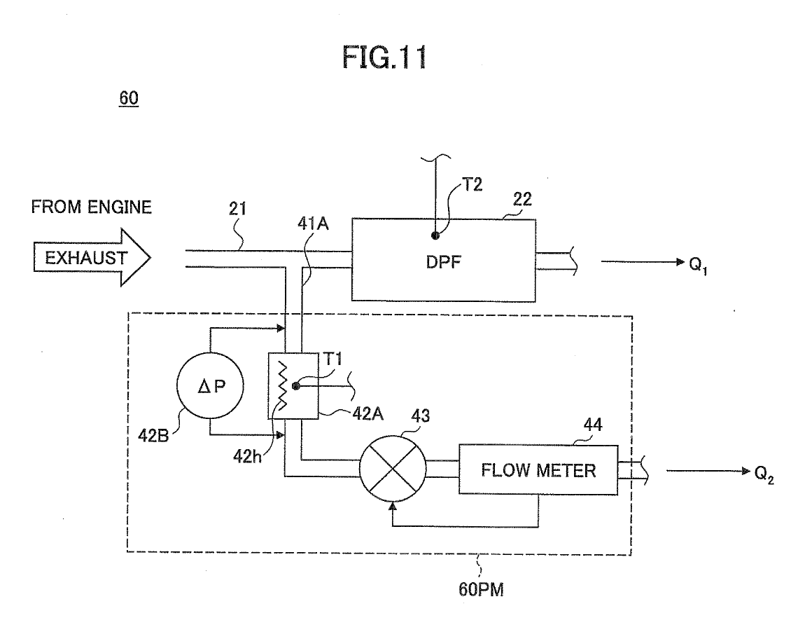

FIG. 11 depicts a diesel engine exhaust gas purifying apparatus 60 including a particulate matter concentration measuring apparatus 60PM (PM sensor) according to another embodiment of the present invention.

The diesel engine exhaust gas purifying apparatus 60 is similar in configuration to the diesel engine exhaust gas purifying apparatus 20 depicted in FIG. 1. With reference to FIG. 11, an exhaust gas collecting line 41A branches from the exhaust line 21 upstream of the particulate matter capturing filter (DPF) 22. In FIG. 11, units or components similar to those of the foregoing embodiment are designated with similar reference numerals or signs and their description is omitted.

In the configuration of the particulate matter concentration measuring apparatus 60PM according to the Second Embodiment of the present invention depicted in FIG. 11, the exhaust gas that has yet to pass through the particulate matter capturing filter (DPF) 22 is captured by the particulate matter detection filter 42A. Based on the amount of the captured particulate matter, the following process is performed, in addition to the processes according to the foregoing Equations (1) through (3).

Namely, because the particulate matter concentration “PM_{conc}” in the exhaust gas is the same whether in the exhaust gas collecting line 41A or in the exhaust line 21, the amount of the particulate matter “PM_{enter full filter}” (g/h) that passes through the exhaust line 21 can be determined by the following expression:

PM_{enter full filter}(g/h)=PM_{conc}(g/m³)×Q1(m³/h) (Equation 4)

where “Q1” is an exhaust gas flow rate in the exhaust line 21.

In this way, the amount of the particulate matter that accumulates in the particulate matter capturing filter (DPF) 22 can be estimated. “Q1”, which is the flow rate of the exhaust gas that passes through the particulate matter capturing filter (DPF) 22, may be determined by actual measurement or estimated from an operation status of the engine.

In the configuration of the particulate matter concentration measuring apparatus 60PM according to the Second Embodiment of the present invention depicted in FIG. 11, there is further provided a valve 43 in the exhaust gas collecting line 41A. The valve 43 is controlled by the flow rate measuring unit 44, as in the case of the conventional particulate matter concentration measuring apparatus 20PM of FIG. 1, in order to control the exhaust gas flow rate in the exhaust gas collecting line 41A to a predetermined value “Q2”.

Because a deposit of the particulate matter collects in the particulate matter detection filter 42A over time, the particulate matter detection filter 42A needs to be regenerated. For this purpose, a heater 42h is installed over the particulate matter detection filter 42A (cell 42b). The heater 42h is activated by power supplied via a drive line (not shown) in order to combust the particulate matter captured in the cell 42b, which mainly consists of carbon (C), thereby regenerating the particulate matter detection filter 42A as needed.

In the Second Embodiment of the present invention also, similar advantageous effects to those of the First Embodiment can be obtained.

While the present disclosure describes various embodiments, these embodiments are to be understood as illustrative and do not limit the claim scope. Many variations, modifications, additions and improvements of the described embodiments are possible. For example, those having ordinary skill in the art will readily appreciate that the flow rate measuring unit in the embodiments of the present invention may be omitted if the flow rate in the exhaust gas collecting line is known in advance.

The temperature measuring unit may be similarly omitted when the property of the exhaust gas may be considered to be constant. The heater in the Second Embodiment of the present invention may be dispensed with if there is no need for the regeneration process. The valve may be eliminated if the flow rate can be accurately measured. In another embodiment, the heater of the Second Embodiment may be provided in the particulate matter concentration measuring apparatus according to the First Embodiment.

In accordance with an embodiment of the present invention, heat resistance to the inflow of high-temperature exhaust gas into a particulate matter concentration measuring apparatus can be improved.

Obviously, numerous modifications and variations of the present invention are possible in light of the above teachings. It is therefore to be understood that within the scope of the appended claims, the invention may be practiced otherwise than as specifically described herein.

What is claimed is:

1. A particulate matter concentration measuring apparatus configured to measure a concentration of a particulate matter in an exhaust gas that flows through a diesel engine exhaust line, the apparatus comprising:
an exhaust gas collecting line branching from the diesel engine exhaust line and having a flow path cross-sectional area smaller than a flow path cross-sectional area of the diesel engine exhaust line;
a particulate matter detection filter disposed in the exhaust gas collecting line; and
a differential pressure detecting unit configured to detect a differential pressure between an inlet and an outlet of the particulate matter detection filter and disposed apart from a downstream end of the particulate matter detection filter in a direction of a flow of the exhaust gas.

2. The particulate matter concentration measuring apparatus according to claim 1, wherein the differential pressure detecting unit is spaced apart from the downstream end of the particulate matter detection filter by about 10 cm or more.

3. The particulate matter concentration measuring apparatus according to claim 1, wherein the differential pressure detecting unit is spaced apart from the downstream end of the particulate matter detection filter by about 200 cm or less.

4. The particulate matter concentration measuring apparatus according to claim 3, wherein the differential pressure detecting unit is spaced apart from the downstream end of the particulate matter detection filter by about 50 cm or less.

5. The particulate matter concentration measuring apparatus according to claim 1, wherein the differential pressure detecting unit comprises a material having a heat resistance of about 120° C. or less as a pressure detecting material.

6. The particulate matter concentration measuring apparatus according to claim 1, comprising:
a heat-radiation structure disposed in the exhaust gas collecting line between the downstream end of the particulate matter detection filter and the differential pressure detecting unit.

7. The particulate matter concentration measuring apparatus according to claim 1, comprising:
a flow rate measuring unit disposed in the exhaust gas collecting line and configured to measure an exhaust gas flow rate in the exhaust gas collecting line.

8. The particulate matter concentration measuring apparatus according to claim 7, comprising:
a flow rate control valve disposed in the exhaust gas collecting line and configured to control the exhaust gas flow rate in the exhaust gas collecting line; and
a control unit configured to control the flow rate control valve based on the exhaust gas flow rate measured by the flow rate measuring unit in order to control the exhaust gas flow rate in the exhaust gas collecting line to a predetermined value.

9. The particulate matter concentration measuring apparatus according to claim 1, wherein a downstream end of the exhaust gas collecting line is connected to a negative pressure unit.

10. The particulate matter concentration measuring apparatus according to claim 1, comprising:
a pump disposed downstream of the particulate matter detection filter in the direction of the flow of the exhaust gas.

11. The particulate matter concentration measuring apparatus according to claim 1, wherein the particulate matter detection filter has a filter volume smaller than a filter volume of a particulate matter capturing filter disposed in the diesel engine exhaust line.

12. The particulate matter concentration measuring apparatus according to claim 1, wherein the exhaust gas collecting line is connected to the diesel engine exhaust line downstream of the particulate matter capturing filter.

13. The particulate matter concentration measuring apparatus according to claim 1, wherein the exhaust gas collecting line is connected to the diesel engine exhaust line upstream of the particulate matter capturing filter.
